(19) United States
(12) Patent Application Publication
(10) Pub. No.: US 2026/0192771 A1
(43) Pub. Date: Jul. 9, 2026

(54) AIRBAG MODULE COMPRISING AN AIRBAG WITH A CONTROLLABLE VENT

(71) Applicant: AUTOLIV DEVELOPMENT AB, Vargarda (SE)

(72) Inventors: Laurent HELLOT, La Feuillie (FR); Laurent BROGGINI, St Samson la poterie (FR)

(21) Appl. No.: 19/132,712

(22) PCT Filed: Nov. 30, 2023
(86) PCT No.: PCT/EP2023/083728

§ 371 Date: May 23, 2025

(30) Foreign Application Priority Data
Dec. 5, 2022 (DE) 10 2022 132 250.5

(51) Int. Cl. B60R 21/2338; B60R 21/239

(52) U.S. Cl. CPC B60R 21/2338; B60R 21/239; B60R 2021/23382; B60R 2021/2395

(57) ABSTRACT

An airbag module with safety feature is described. The airbag module comprises an airbag comprising an outer skin having an impact wall and a lateral wall extending from the impact wall, and an inflator. The airbag further comprises a controllable vent located at the lateral wall and a control tether for controlling said controllable vent, The control tether extends from the controllable vent to a connection connecting the control tether to the outer skin. The control tether controls the controllable vent in such a way that in a deployed state of the airbag, the controllable vent is in a first state when the control tether is under tension and in a second state when the control tether is not under tension, wherein the second state is the less throttled state relative to the first state.

The invention relates to an airbag module according to the preamble of claim 1 and a motor vehicle comprising such an airbag module according to claim 11.

This invention especially relates to a passenger frontal airbag module of a passenger car, also referred to as “passenger airbag module”. As most frontal airbag modules, such a passenger airbag module comprises an airbag, an accommodation unit for this airbag and an inflator. The accommodation unit (usually comprising a housing) of such an airbag module is located in the instrument panel of the car on the passenger side and serves for protecting the passenger in case of a frontal crash.

Such passenger airbag modules are widely used in the automotive technology and are parts of almost every modern passenger car.

In some respects the demands on such an airbag module (especially its airbag) are higher than the demands on a driver airbag module which is located in the steering wheel. The reasons for that are the following:

Usually the volume of a passenger airbag is substantially larger than the volume of the driver airbag of the same car, since the distance between the accommodation unit and the person to be protected is larger than in the case of a driver airbag module. This of course makes it necessary to use a stronger inflator which usually leads to a quite “aggressive” deployment behavior of the airbag, especially in early deployment stages. As is known, the deploying airbag can be a threat for the person to be protected, especially if this person is not in its standard sitting position, but in a “forward-leaning-position” in which the head of the passenger is closer to the accommodation unit than in the standard sitting position (so called “out-of-position” OoP). To make the situation worse, such out-of-position scenarios happen more frequently in case of a passenger than in case of a driver (when driving, the driver is substantially all the time in his standard sitting position).

So, measures should be taken in order to at least reduce the risk for the passenger to be injured by the deploying airbag in case of an OOP scenario, especially if the passenger leans forward towards the windscreen/instrument panel.

One measure which is often taken is a pure geometrical one: If the geometry of the vehicle allows it, the accommodation unit for the airbag is often arranged in such a way that the airbag initially deploys substantially upwards towards the windscreen such that it is very unlikely that a body part of a passenger is hit by the deploying airbag in a very early stage.

Another measure is to provide at least one controllable vent in such a way that this controllable vent opens in the case of an OoP situation as described above. Such controllable vents are known in the art and usually one distinguishes between controllable vents that are controlled actively by means of an actuator which is triggered by a sensor signal, and controllable vents that are controlled passively by the deploying airbag itself. In both cases it is known to use a control tether that controls the controllable vent in such a way that in a deployed state of the airbag the controllable vent is in a first (usually closed) state when the control tether is under tension and in a second (usually open) state when the control tether is not under tension.

In case of a passively controlled vent, the following layout of an airbag module is known in the art: The airbag of the airbag module comprises an outer skin having an impact wall and a lateral wall extending from the impact wall. In the non-deployed state, this airbag is accommodated in an accommodation unit and an inflator is attached to the accommodation unit. The airbag further comprises a controllable vent located at the lateral wall, and a control tether for controlling said controllable vent. The control tether extends from said controllable vent to a connection connecting the control tether to the outer skin. The control tether controls the controllable vent in such a way that in a deployed state of the airbag, the controllable vent is in a first state when the control tether is under tension and in a second state when the control tether is not under tension, wherein the second state is the less throttled state relative to the first state.

In some modern car designs it is desired to arrange a large display between an upper surface of the instrument panel and the windscreen. For this reason it is often not possible to arrange the accommodation unit in such a way that the airbag initially deploys essentially upwards. As described above, this is a drawback in view of protecting the passenger from the deploying airbag in an OoP scenario.

Starting from this prior art it is an object of the invention to provide an airbag module whose airbag has a passively controllable vent which helps to protect the passenger in an OoP scenario, especially in a geometry in which the airbag expands essentially towards the passenger in an early deployment stage, the airbag expands essentially towards the passenger.

This task is solved by means of an airbag module having the features of claim 1. A motor vehicle comprising such an airbag module is defined in claim 11.

It turned out that especially in case of the above described geometry, very good results can be obtained when the connection of the control tether is located at the impact wall and the control tether does not extend directly from there to the controllable vent in a straight line but is deflected by a deflection feature such that the tensioned control tether is a least in sections V-shaped, meaning that the control tether shows a first section extending between the controllable vent and the deflection feature and a second section extending between the deflection feature and the connection to the impact wall.

Because of this geometry, the controllable vent remains tightly closed during unhindered deployment of the airbag but is very quickly opened when the impact wall of the deploying airbag hits an obstacle, for example the head of the passenger.

It further turned out that best results can often be obtained when the angle between the first section and the second section of the control tether is an acute angle, preferable an angle between 10° and 60°. In order to achieve this, it can be preferred that the first deflection feature is located opposite the impact wall.

In one embodiment, the first deflection feature is a first deflection element being attached to the inner surface of the outer skin. This deflection element is preferably made of a flexible material, for example a common airbag material. This has the advantage that the airbag can be completely manufactured before it is attached to its accommodation unit and/or inflator.

In an alternative embodiment, the first deflection feature is a deflection element being attached to one of the inflator, the housing and a mounting element attaching the inflator to the housing. This has the advantage that the deflection feature has a very clearly defined position which does not at all change during the deployment of the airbag.

In some applications it can be advantageous to provide two controllable vents, for example for redundancy or in order to achieve stronger ventilation. In this case the Airbag module comprises an additional controllable vent and the control tethers defines a shared control tether for controlling both controllable vents, or an additional tether for controlling the additional controllable vent is provided. Further, the airbag module comprises a second deflecting feature for deflecting the additional control tether or the part of the shared control tether controlling the additional controllable vent. In this manner a symmetrical layout can be realized.

In order to avoid that the control tether applies a two high force on the controllable vent in the case that the airbag deploys unhinderedly, it can be preferred to provide an additional tether connecting the impact wall with an inner surface of the outer skin. Alternatively, the control tether comprises a third section connecting the impact wall with an inner surface of the outer skin, wherein this third section does not transfer a force to the controllable vent.

In a preferred embodiment, the controllable vent comprises a blocking element that is located between a first layer and a second layer at least in sections when the controllable vent is in its first state, wherein the first layer comprises a first hole and the second layer comprises a second hole and the first hole and the second hole overlap at least partially. The blocking element is connected to the first section of the control tether. The blocking element stays in its original blocking position as long as the outer skin deploys freely and when the outer skin is completely deployed, but is pushed through the hole in the outer layer when the impact wall hits an obstacle such that the control tether cannot reach its tensioned state.

Especially good results can be obtained when the blocking element is substantially triangle-shaped and the first section of the control tether is connected to one apex of the triangular blocking element.

In order to improve the gas tightness in the first state of the controllable vent, it can be preferred that at least the end of the tether being attached to the blocking element comprises two legs both being attached to the blocking element. By this measure, the blocking element is stabilized and kept in a flat shape at least in the first state of the controllable vent. This can help to improve the gas tightness.

The invention will now be described by means of preferred embodiments in view of the figures. The figures show:

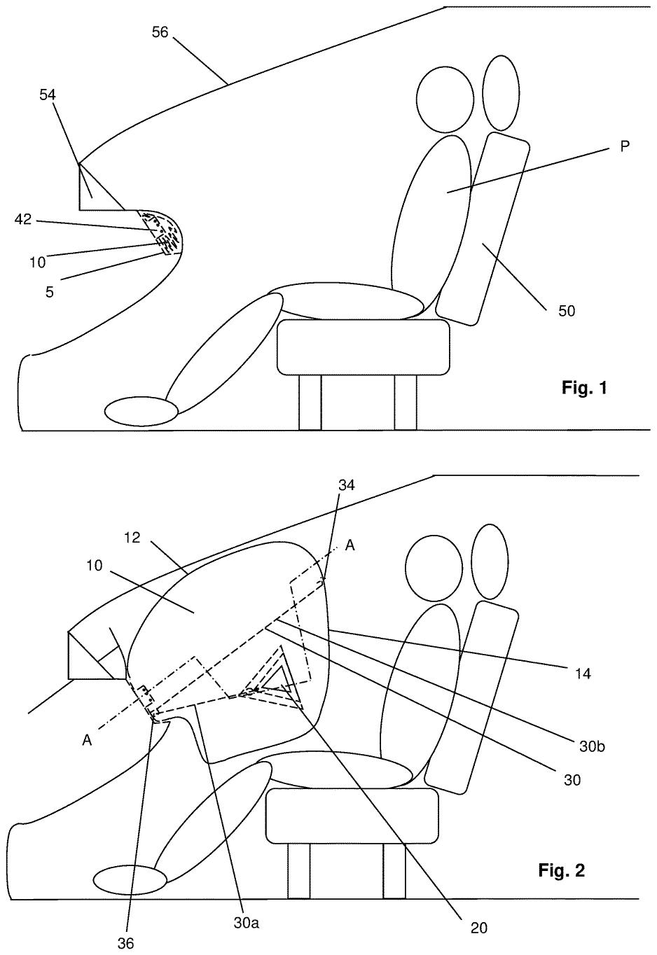

FIG. 1: A schematic representation of a front part of a vehicle on the passenger side, wherein an airbag of an airbag module is in its undeployed state,

FIG. 2: The items shown in FIG. 1 in a state in which the airbag of the airbag module is deployed,

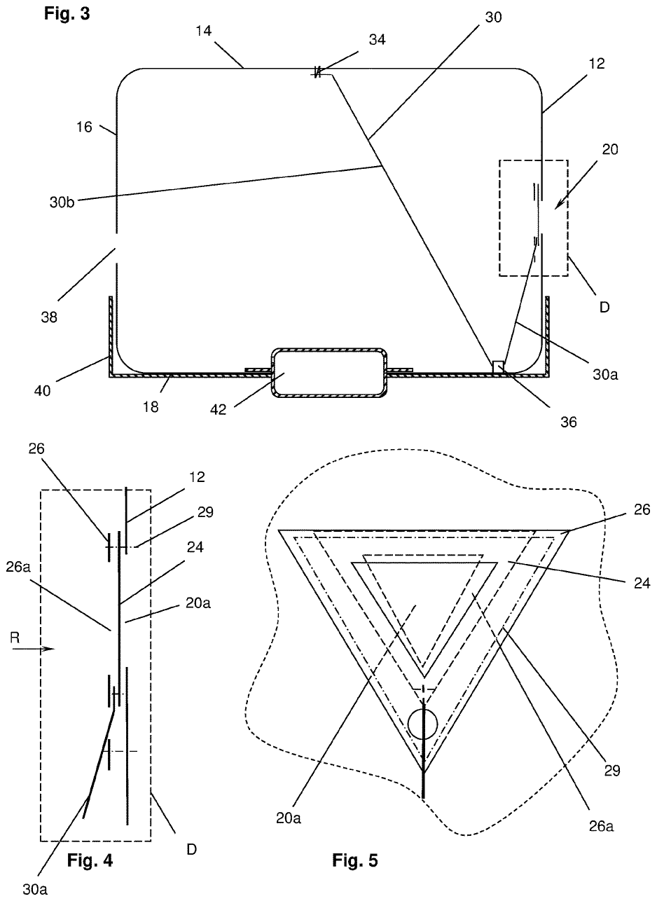

FIG. 3: The airbag module of FIG. 2 in a schematic sectional view taken along plane A-A of FIG. 2,

FIG. 4: The detail D of FIG. 3,

FIG. 5: The controllable vent shown in FIG. 4 in a side view from direction R in FIG. 4,

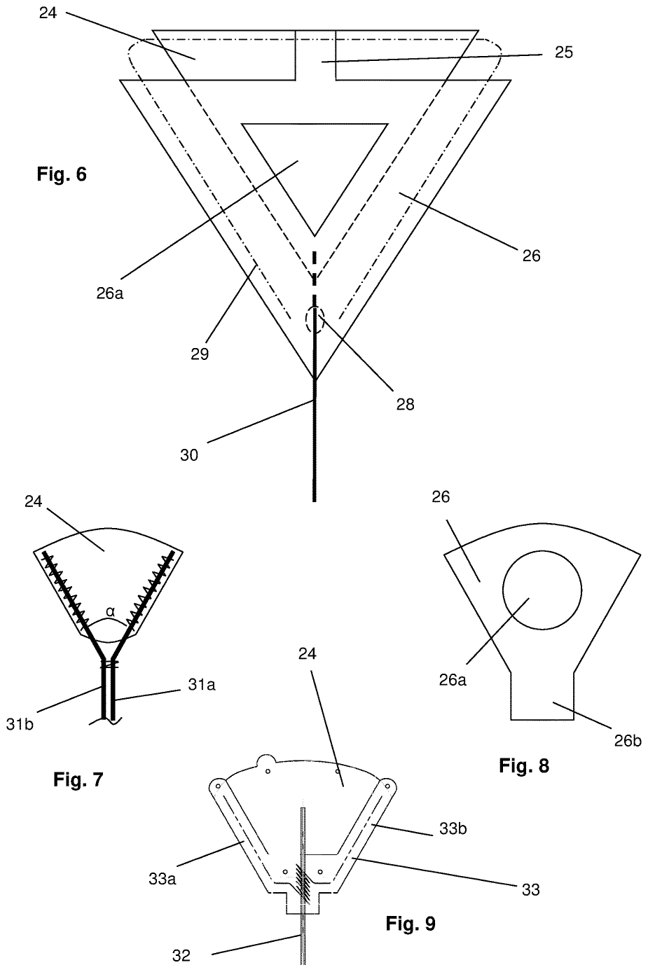

FIG. 6: An alternative embodiment of the controllable vent in a representation substantially according to FIG. 5,

FIG. 7: An alternative embodiment of a blocking element of the controllable vent,

FIG. 8: An alternative embodiment of the second layer,

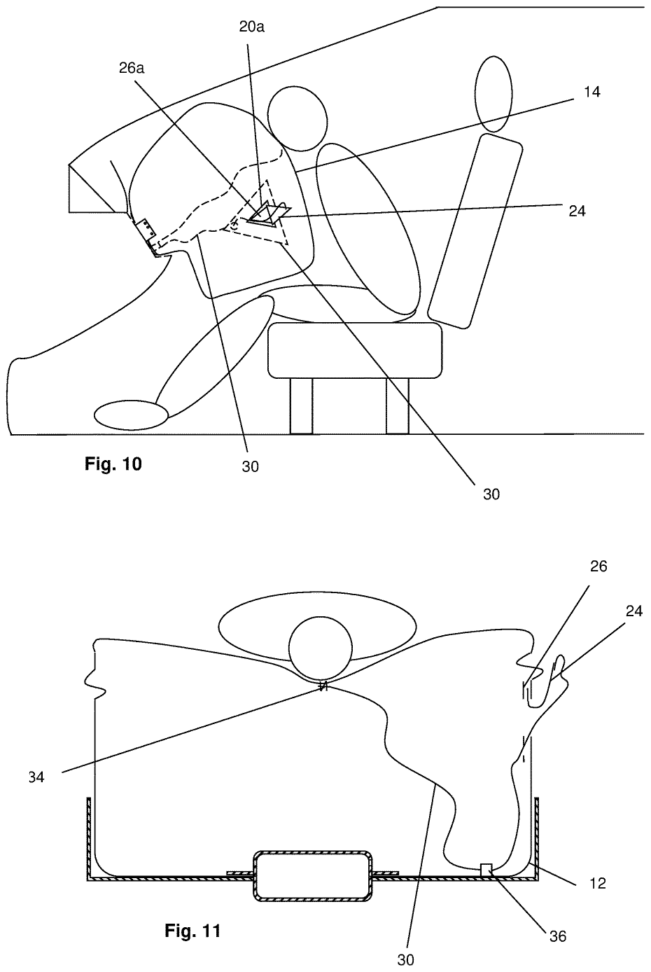

FIG. 9: A further alternative embodiment of the blocking element and the control tether attached to this blocking element,

FIG. 10: Substantially what is shown in FIG. 2 an OoP event, in which a passenger is leaned forward when the airbag deploys,

FIG. 11: What is shown in FIG. 10 in the representation according to FIG. 3 but with passenger being shown,

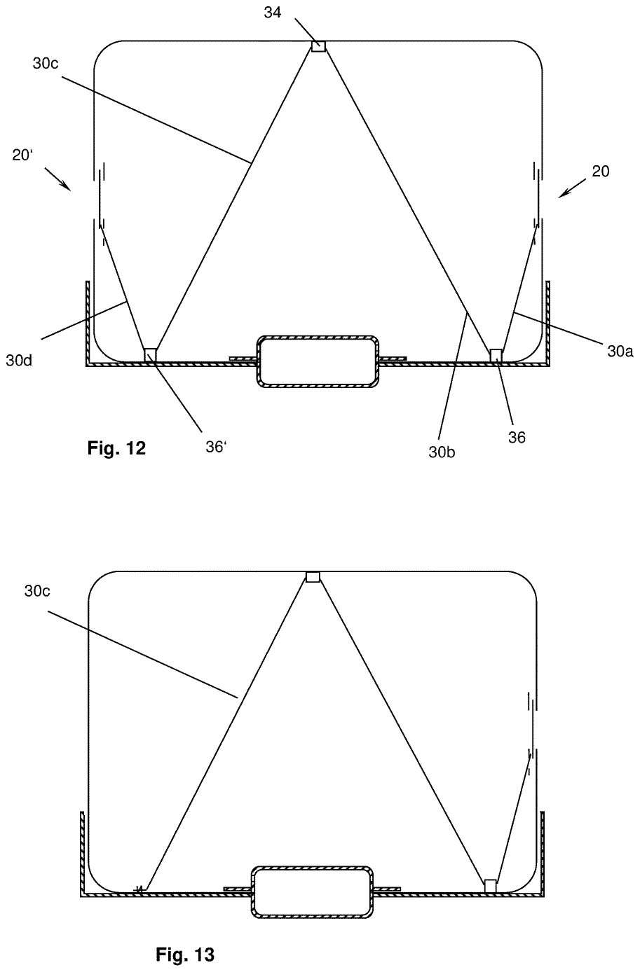

FIG. 12: A second embodiment of the airbag module in a representation according to FIG. 3,

FIG. 13: A third embodiment of the inventive airbag module in a representation according to FIGS. 3 and 12,

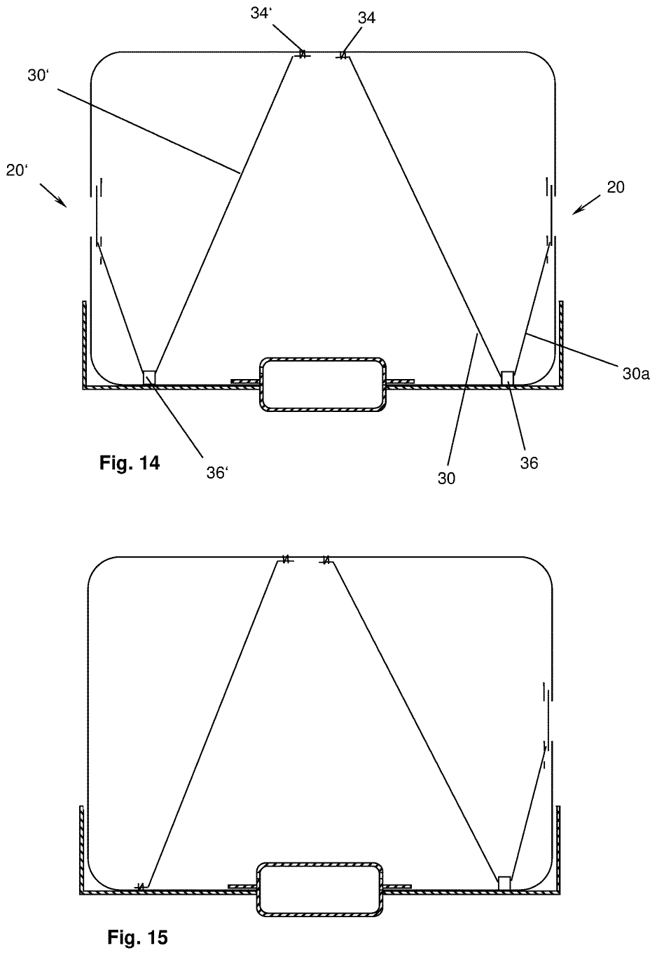

FIG. 14: A fourth embodiment of the inventive airbag module in representation according to FIG. 13,

FIG. 15: A fifth embodiment of the inventive airbag module in a representation according to FIG. 14.

FIG. 1 shows schematically the passenger side of a passenger car. A passenger P is seated on a passenger-side vehicle seat 50 and faces a windscreen 56 and an instrument panel 52. A monitor 54 is located between the upper end of the instrument panel 52 and the windscreen 56. An airbag module 5 comprising an airbag 10 and an inflator 42 is hidden behind the surface of the instrument panel 52, as is generally known in the prior art. The airbag module further comprises an accommodation unit, but in FIG. 1 this accommodation unit is not shown in detail. Due to the position of the monitor 54, the deployment opening of the airbag module substantially points towards the passenger P (not towards the windscreen as is often the case with passenger airbag modules according to the prior art). This of course means that the airbag 10 deploys directly into a direction towards the passenger P.

FIG. 2 shows the items shown in FIG. 1 with the airbag 10 being completely deployed. The passenger P is (as in FIG. 1) in the standard sitting position (before he substantially starts to move towards the airbag due to inertia forces), such that the airbag 10 can deploy unhinderedly. FIG. 3 also shows the airbag in its fully deployed state in a cross-sectional view along plane A-A in FIG. 1. In this Figure, one can also see the housing 40 which is a part of the accommodation unit. The cover of the accommodation unit (which can be integral with the instrument panel) is not shown. The inflator 42 is mounted to the housing 40 by means of a flange as is known in the art and this flange also attached the airbag 10 to the housing 40.

The airbag 10 comprises of course an outer skin 12 which geometrically has an impact wall 14, a support wall 18 and a lateral wall 16 connecting the impact wall 14 and the support wall 18. Often, the impact wall, the support wall 18 and the lateral wall 16 are made from separate cuttings and especially the lateral wall 16 is made of at least one cutting being connected to both, the impact wall and the support wall 18.

A controllable vent 20 is provided in the lateral wall 16 and the airbag 10 further comprises a control tether 30 for controlling this controllable vent 20.

The structure of the controllable vent 20 is best shown in FIGS. 4 and 5: This controllable vent 20 comprises a hole 20a in a first layer (which is in this embodiment the lateral wall of the outer skin 12 of the airbag), a second layer 26 which is in this embodiment located on the inner side of the outer skin 12 and which comprises a hole 26a at least overlapping the hole 20a in the first layer, and a blocking element 24 being located between the first layer (the outer skin 12) and the second layer 26 and covering the two holes 20a and 26a. The second layer 26 as well as the blocking element 24 is usually made of a flat material, especially standard airbag material (the same material as the outer skin 12). As can be seen from FIG. 5, the second layer 26 and the blocking element 24 are triangular-shaped and connected via a connecting seam 29. This connecting seam 29 extends substantially along all edges of the second layer 26 but only along one edge of the blocking element 24. The apex of the blocking element 24 remote from the edge connected via the connecting seam 29 is connected to one end of the control tether 30. The second layer 26 comprises a hole 28 for the control tether through which this control tether 30 extends.

As can best be seen from FIG. 4, the blocking element 24 blocks the hole in the first layer 20a and the hole 26a in the second layer 26 when held in place by the control tether 30 such that the controllable vent 20 is in a blocked first state when the control tether 30 is under tension. It is easy to understand that, when the airbag is deployed (meaning that the gas pressure inside the outer skin 12 of the airbag exceeds the pressure outside the airbag 10) and the control tether 30 is not under tension, the blocking element 24 is pushed through the hole 20a in the outer skin such that the controllable vent 20 transits to an open second state.

According to the invention and as can best be seen from FIG. 3, the control tether 30 extends from the controllable vent 20, namely its blocking element 24, to the impact wall 14 to which it is connected by means of a connection in form of a connecting seam 34. But the control tether does not extend directly from the controllable vent 20 to the impact wall 14, but is guided through a deflection feature 36 which is here in form of a deflection flap 36 connected to the support wall 18. Because of the guiding through the deflection element 36 the control tether is divided into a first section 30a and a second section 30b. It is important to notice that the deflection flap 36 deflects the control tether 30 in a sliding manner. The effect of the deflection of the control tether 30 will be described later especially in view of FIGS. 10 and 11, but first, alternative embodiments of the controllable vent 20 are described in view of FIGS. 6 to 9, wherein it needs to be mentioned that the working principle of the controllable vent is maintained.

FIG. 6 shows an embodiment of the controllable vent 20 in a representation according to FIG. 5. Here, the blocking element 24 and the second layer 26 are sections of a single piece of fabric and the blocking element 24 and the second layer 26 are connected to one another by means of a connecting section 25. As in the first embodiment, the blocking element 24 and the second layer 26 are triangle-shaped, but in contrast to the embodiment of FIG. 5, these triangles have substantially the same size, but are arranged offset from one another. Like in the first embodiment, a connecting seam 29 is provided but in contrast to the first embodiment this connecting seam 29 has no section which goes through both, the blocking element 24 and the second layer 26. This can have advantages regarding the force contribution and the tightness of the controllable vent when it is in its first state. Like in the first embodiment, a hole 28 for the tether is provided in the second layer 26.

FIG. 7 shows a blocking element 24 which is also substantially triangle-shaped in a sense that it has two edges that define an acute angle α. Two legs 33a, 33b of the control tether 30 are attached to the blocking element 24 along the just mentioned edges such that these legs 33a, 33b also enclose the acute angle α. This measure can also contribute to a better force transmittance and to a better tightness of the controllable vent when it is in its first state. This geometry can also be applied to the blocking elements 24 as shown in FIGS. 5 and 6. In the embodiment of FIG. 7 the control tether 30 comprises two strands 31a, 33b and the legs 33a, 33b are the end sections of those strands 31a, 31b. FIG. 8 shows a variation to the embodiment of FIG. 7: Here, the control tether 30 is comprised of a main part 32 and an attachment part 33 which is basically V-shaped and thus has two legs 33a, 33b. As in the embodiment of FIG. 7, those legs 33a, 33b are attached to the blocking element 24 along the edges of this blocking element. The attachment between the blocking element 24, the attachment part 33 of the control tether and the main part of the control tether can be done by a single seam.

FIG. 9 shows an embodiment of the second layer 26 which is especially suitable for the blocking element-tether-combinations as shown in FIGS. 7 and 8. Here, the second layer 26 has a tunnel section 26B which guides a part of the control tether 30.

In view of FIGS. 10 and 11 the working principle of the invention is described:

When the occupant is sitting in a bent-forward-position when the airbag deploys, the impact wall 14 of course comes into contact with the occupant at a very early point in time. As a consequence of this, the control tether 30 is never under tension and due to the pressure that rises inside the outer skin 12 very quickly because the outer skin 12 of the airbag cannot deploy freely, the blocking element 24 is pushed out of the hole 20a very early such that gas is released from the inside of the outer skin 12 and the further deployment of the airbag 10 is less aggressive. So, a quickly reacting safety vent for an OoP situation is provided.

In contrast, when the airbag deploys freely (see for example FIG. 2) the blocking element 24 stays in its sandwiched place until the airbag is fully deployed and is then held by the control tether.

As is shown in FIG. 12, it would of course also be possible to provide two controllable vents 20, 20′ preferably in a symmetric matter. Here, a single control tether 30 could be used which is slidingly connected to the impact wall 14 by means of a connection flap 34. In this case, the control tether has four sections 30a to 30d. Providing two controllable vents 20, 20′-especially in a symmetric manner as shown FIG. 12—has essentially two advantages: First, the amount of gas that is released in an OoP situation is of course enhanced, and second, the force transmitted to the impact wall 14 is symmetricized.

FIG. 13 shows a variation to the embodiment of FIG. 12 which also makes use of a symmetric force transmission to the support wall 18, but only uses one controllable vent.

As shown in FIG. 14, of course also two completely separated control tethers 30, 30′ can be used instead of one control tether being held at the impact wall 14 in a sliding manner.

And finally, the layout as described in view of FIGS. 1 to 3 can be combined with an additional tether 38 that purely serves for limiting the inflation depth (FIG. 15).

List of reference numbers

| | |
|---|---|
| 5 | airbag module |
| 10 | airbag |
| 12 | outer skin |
| 14 | impact wall |
| 16 | lateral wall |
| 18 | support wall |
| 20, 20′ | controllable vent |
| 20a | hole in first layer |
| 22 | first hole |
| 24 | blocking element |
| 25 | connection between blocking element and second layer |
| 26 | second layer |
| 26a | hole in second layer |
| 26b | tunnel section |
| 28 | hole for tether |
| 30, 30′ | control tether |
| 30a, 30b, | sections of control |
| 30c, 30d | |
| 31a, 31b | strand |
| 32 | main part of control tether |
| 33 | attachment part of control tether |
| 33a, 33b | legs |
| 34 | connection / connecting seam connection flap |
| 36 | deflection element / deflection flap |
| 38 | additional tether |
| 40 | housing |
| 42 | inflator |
| 50 | vehicle seat |
| 52 | instrument panel |
| 54 | monitor |
| 56 | windscreen |

1. Airbag module comprising:
an airbag comprising an outer skin having an impact wall and a lateral wall extending from the impact wall,
an accommodation unit that houses the airbag when the airbag is in its un-deployed state, and
an inflator attached to the accommodation unit,
wherein the airbag further comprises
a controllable vent located at the lateral wall, and
a control tether for controlling said controllable vent, said control tether extending from said controllable vent to a connection connecting the control tether to the outer skin,
wherein the control tether controls the controllable vent in such a way that in a deployed state of the airbag, the controllable vent is in a first state when the control tether is under tension and in a second state when the control tether is not under tension, wherein the second state is the less throttled state relative to the first state, wherein
the connection connects the control tether to the impact wall, and
the control tether is guided through a first deflection feature, such that the control tether is deflected by the deflecting feature at least when the control tether is under tension so that the control tether shows a first section extending between the controllable vent and the deflection feature, and a second section extending between the deflection feature and the connection to the impact wall.

2. The airbag module according to claim 1, wherein the first deflection feature is located opposite the impact wall.

3. The airbag module according to claim 1, wherein the first section and the second section of the control tether enclose an acute angle, preferably an angle between 10° and 60°.

4. The airbag module according to claim 1, wherein the first deflection feature is a first deflection element being attached to the inner surface of the outer skin, wherein this first deflection element is preferably made of a flexible material to form a flap.

5. The airbag module according to claim 1, wherein the first deflection feature is a deflection element being attached to one of the inflator, the accommodation unit and a mounting element attaching the inflator to the accommodation unit.

6. The airbag module according to claim 1, wherein
the airbag module comprises an additional controllable vent, the control tethers defines a shared control tether for controlling both controllable vents, or an additional control tether for controlling the additional controllable vent is provided,
an additional deflection feature for deflecting the additional control tether or the part of the shared control tether controlling the additional controllable vent is provided.

7. The airbag module according to claim 1, wherein an additional tether connecting the impact wall with one of the inner surface of the outer skin, the inflator, the accommodation unit and a mounting element attaching the inflator to the accommodation unit, especially to a housing being a part of the accommodation unit, is provided or that the control tether comprises a third section connecting the impact wall with one of inner surface of the outer skin, the inflator, the accommodation unit and a mounting element attaching the inflator to the accommodation unit, especially to a housing being a part of the accommodation unit.

8. The airbag module according to claim 1, wherein the controllable vent comprises a blocking element being located between a first layer and a second layer at least in sections when the controllable vent is in its first state, wherein the first layer comprises a first hole and the second layer comprises a second hole and the first hole and the second hole overlap at least partially.

9. The airbag module according to claim 8, wherein the blocking element is substantially triangle-shaped.

10. The airbag module according to claim 9, wherein at least the end of the control tether being attached to the blocking element comprises two legs both being attached to the blocking element.

11. A motor vehicle comprising a windscreen, an instrument panel, and an airbag module according to claim 1, and a monitor being located between the instrument panel and the windscreen, and an airbag module which comprises:
an airbag comprising an outer skin having an impact wall and a lateral wall extending from the impact wall,
an accommodation unit that houses the airbag when the airbag is in its un-deployed state, and
an inflator attached to the accommodation unit,
wherein the airbag further comprises a controllable vent located at the lateral wall, and
a control tether for controlling said controllable vent, said control tether extending from said controllable vent to a connection connecting the control tether to the outer skin,
wherein the control tether controls the controllable vent in such a way that in a deployed state of the airbag, the controllable vent is in a first state when the control tether is under tension and in a second state when the control tether is not under tension, wherein the second state is the less throttled state relative to the first state,
wherein the connection connects the control tether to the impact wall, and
the control tether is guided through a first deflection feature, such that the control tether is deflected by the deflecting feature at least when the control tether is under tension so that the control tether shows a first section extending between the controllable vent and the deflection feature, and a second section extending between the deflection feature and the connection to the impact wall.
